(19) United States
(12) Patent Application Publication
(10) Pub. No.: US 2020/0029771 A1
(43) Pub. Date: Jan. 30, 2020

(54) Managing Cleaning Robot Behavior

(71) Applicant: QUALCOMM Incorporated, San Diego, CA (US)

(72) Inventors: Daniel Warren MELLINGER, III, Philadelphia, PA (US); Stephen Marc CHAVES, Philadelphia, PA (US); Michael Joshua SHOMIN, Philadelphia, PA (US); Matthew Hyatt TURPIN, Waltham, MA (US); John Anthony DOUGHERTY, Philadelphia, PA (US); Ross Eric KESSLER, Philadelphia, PA (US); Jonathan Paul DAVIS, Philadelphia, PA (US); Travis VAN SCHOYCK, Princeton, NJ (US)

(21) Appl. No.: 16/043,532

(22) Filed: Jul. 24, 2018

(51) Int. Cl. A47L 11/40; A47L 9/28; F24F 11/30; G05D 1/00; G05D 1/02

(52) U.S. Cl. CPC A47L 11/4011; A47L 9/2805; A47L 9/2894; F24F 11/30; G05D 2201/0215; G05D 1/0219; A47L 2201/04; A47L 2201/06; G05D 2201/0203; G05D 1/0088

(57) ABSTRACT

Various embodiments include processing devices and methods for managing cleaning robot behavior. In some embodiments, a processor of the cleaning robot may determine operational information about operations of a heating, ventilation, and air conditioning (HVAC) system for at least one room in a structure. The processor may determine a time when operation of the HVAC system will end based on the determined operational information. The processor may generate an instruction for the cleaning robot to schedule an operation of the cleaning robot for a time after operation of the HVAC system will end. The processor may execute the generated instruction to perform the operation of the cleaning robot after operation of the HVAC system ends.

### BACKGROUND

Autonomous and semiautonomous robotic devices are being developed for a wide range of applications. One such application involves robotic cleaning devices, or cleaning robots. Early cleaning robots were robotic vacuum cleaners that had various problems including colliding with objects and leaving areas uncleaned. More sophisticated cleaning robots have been developed since that time. For example, cleaning robots may be programmed to clean on a predetermined schedule, such as at certain dates and times. However, such cleaning robots blindly follow their cleaning schedule, and are unable to dynamically adapt their cleaning activities to environmental conditions.

### SUMMARY

Various aspects include methods that may be implemented on a processor of a cleaning robot for managing cleaning behavior by a cleaning robot. Various aspects may include determining, by a processor of a cleaning robot, operational information about operations of a heating, ventilation, and air conditioning (HVAC) system for at least one room in a structure in which the cleaning robot is located, determining, by the processor, a time when operation of the HVAC system will end based on the determined operational information, generating, by the processor, an instruction to schedule an operation of the cleaning robot for a time after operation of the HVAC system will end, and executing, by the processor, the generated instruction to perform the operation of the cleaning robot after operation of the HVAC system ends.

In some aspects, the determined operational information about operations of the HVAC system may include an HVAC system operation schedule. In some aspects, the determined operational information about operations of the HVAC system may include information received from a thermostat device of the HVAC system. In some aspects, determining operational information about operations of the HVAC system may include observing, by the processor, operations of the HVAC system for the at least one room in the structure over time, and determining, by the processor, operational information about the operations of the HVAC system based on the observations.

In some aspects, determining operational information about operations of the HVAC system may include observing, by the processor, ambient temperatures in the at least one room in the structure over time, observing, by the processor, operations of the HVAC system for the at least one room in the structure over time, correlating, by the processor, observed operations of the HVAC system to observed ambient temperatures, and determining, by the processor, operational information about the operations of the HVAC system based on correlations of observed operations of the HVAC system to observed ambient temperatures. In some aspects, generating an instruction to schedule an operation of the cleaning robot for a time after operation of the HVAC system will end may include scheduling the operation of the cleaning robot to begin a period of time after the time when operation of the HVAC system will end. In some aspects, generating an instruction to schedule an operation of the cleaning robot based on the time when operation of the HVAC system ends may include determining a location of operation of the HVAC system within the structure, and determining a location for operations of the cleaning robot based on the determined location of operation of the HVAC system within the structure.

In some aspects, generating an instruction to schedule an operation of the cleaning robot based on the time when operation of the HVAC system ends may include determining a start time of the operation of the HVAC system, and determining a stop time for the operation of the cleaning robot based on the start time of the operation of the HVAC system. Some aspects may further include observing, by the processor, ambient temperatures in the at least one room in the structure over time, and determining, by the processor, an ambient temperature trend based on the observed ambient temperatures. In such aspects, determining the time when operation of the HVAC system will end based on the determined operational information, may include determining, by the processor, the time when operation of the HVAC system will end based on a comparison of the ambient temperature trend and a temperature threshold of operation of the HVAC system.

Some aspects may further include observing, by the processor, ambient temperatures in the at least one room in the structure over time, determining, by the processor, an ambient temperature trend based on the observed ambient temperatures, determining, by the processor, a start time for operation of the HVAC system based on a comparison of the ambient temperature trend and a temperature threshold of operation of the HVAC system, determining, by the processor, a stop time for operation of the cleaning robot based on the determined start time of the operation of the HVAC system, generating, by the processor, an instruction to schedule stopping operations of the cleaning robot at the determined stop time, and executing, by the processor, the generated instruction to stop operations of the cleaning robot. Some aspects may further include monitoring, by the processor, for HVAC system operations while performing the operation of the cleaning robot, and executing, by the processor, an instruction to stop the operation of the cleaning robot in response to detecting HVAC system operation while performing the operation of the cleaning robot.

Various aspects further include a cleaning robot having a processor configured with processor executable instructions to perform operations of any of the methods summarized above. Various aspects further include a processing device for use in a cleaning robot and configured to perform operations of any of the methods summarized above. Various aspects include a cleaning robot having means for performing functions of any of the methods summarized above. Various aspects include a non-transitory processor-readable storage medium having stored thereon processor-executable instructions configured to cause a processor of a cleaning robot to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a cleaning robot operating within a communication system according to various embodiments.

FIG. 2 is a component block diagram illustrating components of a cleaning robot according to various embodiments.

FIG. 3 is a component block diagram illustrating a processing device suitable for use in cleaning robots implementing various embodiments.

FIG. 4 is a process flow diagram illustrating a method of managing cleaning robot behavior according to various embodiments.

FIG. 5 is a process flow diagram illustrating a method of managing cleaning robot behavior according to various embodiments.

FIG. 6 is a process flow diagram illustrating a method of managing cleaning robot behavior according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of a cleaning robot that enable the cleaning robot to dynamically adapt autonomous or semiautonomous cleaning behaviors based information obtained from sources external to the cleaning robot.

As used herein, the term “cleaning robot” refers to one of various types of devices including an onboard processing device configured to provide some autonomous or semi-autonomous capabilities. Various embodiments may be used with a variety of propulsion mechanisms, body designs, and component configurations, and may be configured to perform operations in a variety of environments, including airborne cleaning robots, and water-borne cleaning robots and/or some combination thereof. A cleaning robot may be autonomous including an onboard processing device configured to maneuver and/or navigate while controlling cleaning functions of the cleaning robot without remote operating instructions. In embodiments in which the cleaning robot is semi-autonomous, the cleaning robot may include an onboard processing device configured to receive some information or instructions, such as from a human operator (e.g., via a remote computing device), and autonomously maneuver and/or navigate while controlling cleaning functions of the cleaning robot consistent with the received information or instructions. A cleaning robot may include a variety of components that may perform a variety of cleaning functions. Various embodiments may be performed by or adaptable to a wide range of smart cleaning appliances, including smart dishwashers, washing machines, clothing dryers, garbage collectors/emptiers, and other suitable smart cleaning appliances. For conciseness, term “cleaning robot” will be used herein.

Conventional cleaning robots may be programmed to clean on a predetermined schedule, such as at certain dates and times. However, such cleaning robots blindly follow their cleaning schedule, and are unable to dynamically adapt their cleaning activities to environmental conditions and presence, actions and/or plans of humans.

Various embodiments provide methods, and cleaning robot management systems configured to perform the methods of managing cleaning robot behavior to improve the effectiveness of cleaning operations and/or reduce interference with humans. Various embodiments enable a processor of a cleaning robot to dynamically adapt autonomous or semiautonomous behavior of the cleaning robot based upon information received or obtained from sources external to the cleaning robot.

Some embodiments improve the operation of a cleaning robot by dynamically adapting autonomous or semiautonomous behavior of the cleaning robot based upon information regarding heating, ventilation, and air conditioning (HVAC) systems to increase the effectiveness and efficiency of the operation of the cleaning robot. The operation of most HVAC systems circulate dust and other particulates, so operating a cleaning robot before, during, or even immediately after the operation of the HVAC system may be inefficient as dust and/or particulates will simply settle.

In some embodiments, the processor of the cleaning robot may determine operational information about the operations of an HVAC system for at least one room in a structure. In some embodiments, the processor of the cleaning robot may observe operations of the HVAC system (e.g., via one or more sensors of the cleaning robot). In some embodiments, the observed HVAC system operations may include start times and stop times of operation, days of operation, operational dates and times by correlated to a season, and other suitable operational information. In some embodiments, the processor of the cleaning robot may determine one or more locations of HVAC operation, such as one or more specific rooms in the structure in which the HVAC system may perform an operation (e.g., heating, ventilation, cooling, and the like).

In some embodiments, the HVAC system operational information may include HVAC scheduling information in a data structure that may be stored in a memory of an HVAC manager or another similar device that manages the operation of the HVAC system. In some embodiments, the processor of the cleaning robot may be configured to query an HVAC manager or another similar device via a network (e.g., a wireless network) to obtain the HVAC scheduling information. In some embodiments, the processor of the cleaning robot may be configured to receive the HVAC scheduling information that is pushed to the cleaning robot periodically or upon changes to the HVAC schedule. In some embodiments, the processor of the cleaning robot may be configured to store the HVAC scheduling information in memory of the cleaning robot.

In some embodiments, the HVAC system operational information determined by the processor of the cleaning robot may include one or more temperature thresholds of operation of the HVAC system. In some embodiments, the temperature thresholds may include a high temperature threshold at which cooling air conditioning may be started and/or a low temperature threshold at which heating air conditioning may be started. For example, HVAC cooling may be triggered when an ambient temperature increases to the high temperature threshold. As another example, HVAC heating may be triggered when an ambient temperature decreases to the low temperature threshold. In some embodiments, the temperature thresholds may include multiple thresholds that trigger various HVAC operations. For example, when an ambient temperature increases to a first high temperature threshold, HVAC ventilation operations may be triggered, and when the ambient temperature increases to a second high temperature threshold, HVAC cooling operations may be triggered. Other examples are also possible. In some embodiments, the processor of the cleaning robot may determine the one or more temperature thresholds of operation of the HVAC system by observation. In some embodiments, the processor may receive the temperature thresholds from the thermostat device (e.g., in response to a query from the cleaning robot, or pushed to the cleaning robot by the thermostat device, or through another machine-to-machine communication).

In some embodiments, the temperature thresholds of operation of the HVAC system may include one or more temperature thresholds of operation of the HVAC system (e.g., a high temperature threshold, a low temperature threshold, multiple thresholds, and the like), as well as ambient temperature information, information about the location of the thermostat device in the structure, and other suitable information. In some embodiments, the HVAC operations information observed by the processor of the cleaning robot (or received by the processor of the cleaning robot) may include signals from a thermostat device triggering an HVAC operation.

In some embodiments, the processor of the cleaning robot may obtain other information that is useful for dynamically adapting behavior of the cleaning robot to operations of an HVAC system. For example, the processor of the cleaning robot may determine or obtain a temperature outside of the structure. The temperature outside the structure may, for example, be useful in predicting when the HVAC system may turn on and/or turn off As another example, certain HVAC systems may be configured to detect human occupancy of the structure or of a room in the structure. In some embodiments, the processor of the cleaning robot may use a detected human occupancy to determine whether a temperature threshold may change based on human occupancy of the structure/room.

In some embodiments, the processor of the cleaning robot may obtain information from or related to an HVAC system that is useful for dynamically adapting behavior of the cleaning robot to dust conditions in a structure. As an example, the processor of the cleaning robot may determine an air filter status from the HVAC system, such as a total time of use of the air filter. As another example, the HVAC system may compare static air pressure on each side of the air filter to determine the efficiency of the air filter, which may also impact the amount of dust and dirt that will need to be cleaned. Older filters may perform less effectively (e.g., may trap less dust) than newer filters, and thus affect the amount of dust and dirt that will need to be cleaned. In some embodiments, based on the age and/or effectiveness of the air filter, the processor of the cleaning robot may determine a longer period of time after the end of HVAC system operation (e.g., may schedule a later start time for an operation of the cleaning robot).

In some embodiments, the processor of the cleaning robot may obtain information from an HVAC system regarding conditions of the structure that is useful for dynamically adapting behavior of the cleaning robot. As an example, the processor of the cleaning robot may obtain information from the HVAC system that may be useful to determine how dusty the environment may be. In some embodiments, the processor of the cleaning robot may determine a period or length of time to permit dust to settle in the environment following operation of the HVAC system based on the determination of how dusty the environment maybe. For example, the processor of the cleaning robot may obtain information from the HVAC system that enables the processor to determine that a pet lives in the structure. In some embodiments, the processor of the cleaning robot may schedule a later start time for an operation of the cleaning robot following operation of the HVAC system based on the information that a pet lives in the structure. For example, the processor of the cleaning robot may use a machine learning algorithm to determine, based on the information that a pet lives in the structure, that the environment may be relatively dusty, and that a longer period of time may be required after the end of HVAC system operation to enable the relatively greater amount of dust to settle so that it can be cleaned by the cleaning robot.

In some embodiments, the processor of the cleaning robot may observe information about operations of the thermostat device or obtain the information from the thermostat device over time. In some embodiments, the processor of the cleaning robot may obtain the ambient temperature as measured by an onboard temperature sensor. In some embodiments, the processor of the cleaning robot may determine one or more temperature trends tied to time of day, day of week, and calendar date. For example, the processor of the cleaning robot may determine a rate of increase or a rate of decrease of an ambient temperature as function of time. In some embodiments, the processor of the cleaning robot may compare the ambient temperature as measured by an onboard temperature sensor with one or more temperature thresholds of the thermostat device and/or the HVAC system. In some embodiments, the processor of the cleaning robot may determine scheduling information based on one or more temperature trends and one or more temperature thresholds of the thermostat device and/or the HVAC system.

In some embodiments, the processor of the cleaning robot may determine start time and/or a time when operation of the HVAC system ends, and/or determine an operation of the HVAC system based on the scheduling information. In some embodiments, the processor of the cleaning robot may determine the location of operation of the HVAC system (e.g., one or more rooms of a structure).

In some embodiments, the processor of the cleaning robot may generate an instruction for the cleaning robot to schedule an operation of the cleaning robot based on the time when operation of the HVAC system ends. In some embodiments, the processor may generate an instruction for, or schedule, an operation of the cleaning robot to occur after the time when operation of the HVAC system ends. In some embodiments, the generated instruction may include a start time for the operation of cleaning robot. In some embodiments, the start time for the operation of the cleaning robot may include a period of time after the time when operation of the HVAC system ends (e.g., a delay period of time). In some embodiments, the generated instruction may include a stop time for the operation of the cleaning robot. For example, the stop time for the operation of the cleaning robot may be based on a start time of operations of the HVAC system. In some embodiments, the generated instruction may be a location of operation of the cleaning robot. For example, the location of operation of the cleaning robot may be based on a determined location of operation of the HVAC system (e.g., one or more rooms of the structure).

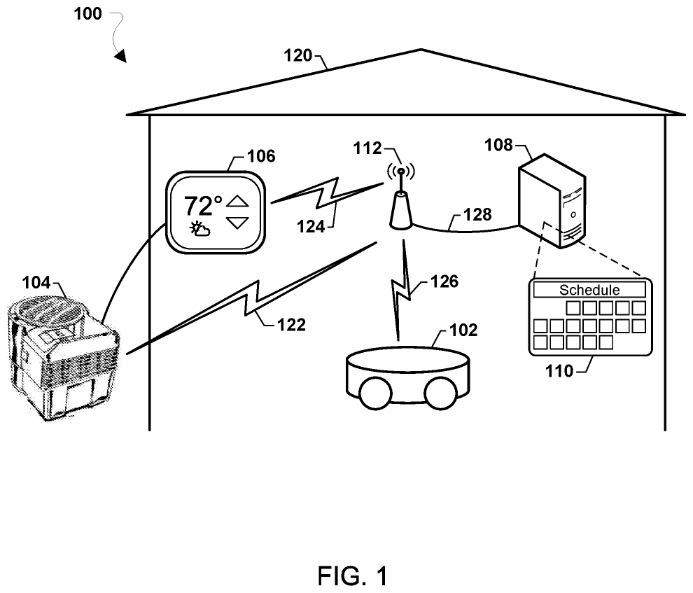

Various embodiments may be implemented within a cleaning robot operating within a variety of communication systems 100, an example of which is illustrated in FIG. 1. With reference to FIG. 1, the communication system 100 may include a cleaning robot 102, an HVAC system 104, a thermostat device 106, and an HVAC manager device 108. In some HVAC systems, thermostat device 106, and an HVAC manager device 108 may be the same device, such as a smart thermostat.

The HVAC system 104 may provide heating, ventilation, and/or air conditioning to one or more rooms or other parts of a structure 120, such as a house or office building. The HVAC system 104 may be in communication with the thermostat device 106, which may provide information about ambient temperatures around the thermostat device 106. The thermostat device 106 may also provide one or more temperature thresholds that may trigger operation of the HVAC system 104. For example, the thermostat device 106 may determine that the ambient temperature meets a threshold, and the thermostat device 106 may send a control signal to the HVAC system 104 to perform heating, cooling, ventilation, or another suitable operation.

The HVAC manager device 108 may include a computing device configured to manage operations of the HVAC system 104. The HVAC manager device 108 may store and manage an HVAC system operation schedule 110. In some embodiments, the HVAC system operation schedule 110 may include dates and times of various scheduled operations of the HVAC system 104. The HVAC manager device 108 may include a wireless communication device 112 that enables wireless communications with the cleaning robot 102, the HVAC system 104, and/or the thermostat device 106 via the communication links 126, 122, and 124, respectively. The HVAC manager device 108 may communicate with the wireless communication device 112 over a wired or wireless communication link 128.

The wireless communication links 122, 124, and 126 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication links 122, 124, and 126 include an Institute of Electrical and Electronics Engineers (IEEE) 802.15.4 protocol (such as Thread, ZigBee, and Z-Wave), any of the Institute of Electrical and Electronics Engineers (IEEE) 16.11 standards, or any of the IEEE 802.11 standards, the Bluetooth® standard, Bluetooth Low Energy (BLE), 6LoWPAN, LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. Further examples of RATs that may be used in one or more of the various wireless communication links within the communication system 100 include 3GPP Long Term Evolution (LTE), 3G, 4G, 5G, Global System for Mobility (GSM), GSM/General Packet Radio Service (GPRS), Enhanced Data GSM Environment (EDGE), Code Division Multiple Access (CDMA), frequency division multiple access (FDMA), time division multiple access (TDMA), Wideband Code Division Multiple Access (W-CDMA), Worldwide Interoperability for Microwave Access (WiMAX), Time Division Multiple Access (TDMA), and other mobile telephony communication technologies cellular RATs, Terrestrial Trunked Radio (TETRA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, and other mobile telephony communication technologies cellular RATs or other signals that are used to communicate within a wireless, cellular or Internet of Things (IoT) network or further implementations thereof.

In various embodiments, the cleaning robot 102 may perform operations within the structure 120. In some embodiments, the cleaning robot 102 may dynamically manage the scheduling and performance of various operations based on information from sources external to the cleaning robot, including information from the HVAC system 104, the thermostat device 106, and/or the HVAC manager device 108, as further described below.

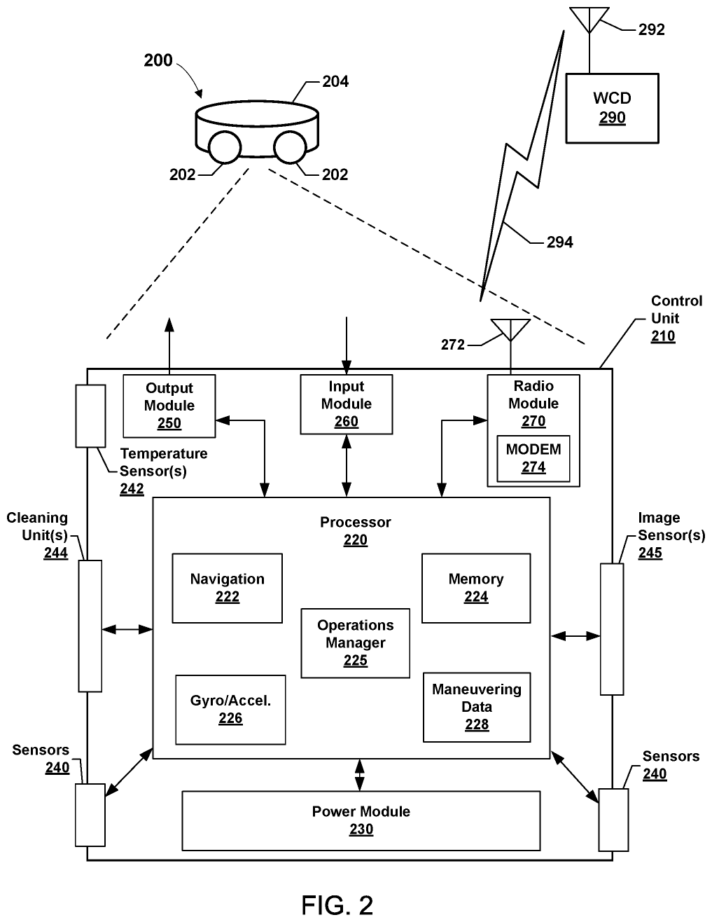

FIG. 2 illustrates an example cleaning robot 200 of a ground vehicle design that utilizes one or more wheels 202 driven by corresponding motors to provide locomotion to the cleaning robot 200. The cleaning robot 200 is illustrated as an example of a cleaning robot that may utilize various embodiments, but is not intended to imply or require that the claims are limited to wheeled ground cleaning robots. For example, various embodiments may be used with a variety of propulsion mechanisms, body designs, and component configurations, and may be configured to perform operations in a variety of environments, including cleaning robots that maneuver at least partially by flying, and water-borne cleaning robots (e.g., pool cleaning robots).

With reference to FIGS. 1 and 2, the cleaning robot 200 may be similar to the cleaning robot 102. The cleaning robot 200 may include a number of wheels 202 and a body 204. The frame 204 may provide structural support for the motors and their associated wheels 202. For ease of description and illustration, some detailed aspects of the cleaning robot 200 are omitted such as wiring, frame structure interconnects, or other features that would be known to one of skill in the art. While the illustrated cleaning robot 200 has wheels 202, this is merely exemplary and various embodiments may include any variety of components to provide propulsion and maneuvering capabilities, such as treads, paddles, skids, or any combination thereof or of other components.

The cleaning robot 200 may further include a control unit 210 that may house various circuits and devices used to power and control the operation of the cleaning robot 200. The control unit 210 may include a processor 220, a power module 230, sensors 240, one or more cleaning units 244, one or more temperature sensors 242, one or more image sensors 245, an output module 250, an input module 260, and a radio module 270.

The processor 220 may be configured with processor-executable instructions to control travel and other operations of the cleaning robot 200, including operations of various embodiments. The processor 220 may include or be coupled to a navigation unit 222, a memory 224, an operations management unit 225, a gyro/accelerometer unit 226, and a maneuvering data module 228. The processor 220 and/or the navigation unit 222 may be configured to communicate with a server through a wireless communication link to receive data useful in navigation, provide real-time position reports, and assess data.

The maneuvering data module 228 may be coupled to the processor 220 and/or the navigation unit 222, and may be configured to provide travel control-related information such as orientation, attitude, speed, heading, and similar information that the navigation unit 222 may use for navigation purposes. The gyro/accelerometer unit 226 may include an accelerometer, a gyroscope, an inertial sensor, an inertial measurement unit (IMU), or other similar sensors. The maneuvering data module 228 may include or receive data from the gyro/accelerometer unit 226 that provides data regarding the orientation and accelerations of the cleaning robot 200 that may be used in navigation and positioning calculations, as well as providing data used in various embodiments for processing images.

The processor 220 may further receive additional information from one or more image sensors 245 (e.g., a camera) and/or other sensors 240. In some embodiments, the image sensor(s) 245 may include an optical sensor capable of infrared, ultraviolet, and/or other wavelengths of light. Information from the one or more image sensors 245 may be used for navigation, as well as for providing information useful in controlling cleaning operations. For example, images of surfaces may be used by the processor 220 to determine a level or intensity of clean operations (e.g., brush speed or pressure) to apply to a given location.

The processor 220 may further receive additional information from one or more other sensors 240. Such sensors 240 may also include a wheel rotation sensor, a radio frequency (RF) sensor, a barometer, a thermometer, a humidity sensor, a chemical sensor (e.g., capable of sensing a chemical in a solid, liquid, and/or gas state), a vibration sensor, a sonar emitter/detector, a radar emitter/detector, a microphone or another acoustic sensor, contact or pressure sensors (e.g., that may provide a signal that indicates when the cleaning robot 200 has made contact with a surface), and/or other sensors that may provide information usable by the processor 220 to determine environmental conditions, as well as for movement operations, navigation and positioning calculations, and other suitable operation.

The power module 230 may include one or more batteries that may provide power to various components, including the processor 220, the sensors 240, the cleaning unit(s) 244, the image sensor(s) 245, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The cleaning robot 200 may be controlled through control of the individual motors of the rotors 202 as the cleaning robot 200 progresses toward a destination. The processor 220 may receive data from the navigation unit 222 and use such data in order to determine the present position and orientation of the cleaning robot 200, as well as the appropriate course towards the destination or intermediate sites. In various embodiments, the navigation unit 222 may include a global navigation satellite system (GNSS) receiver system (e.g., one or more global positioning system (GPS) receivers) enabling the cleaning robot 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), access points that use any of a number of short range RATs (e.g., Wi-Fi, Bluetooth, Zigbee, Z-Wave, etc.), cellular network sites, radio stations, remote computing devices, other cleaning robots, etc.

The cleaning units 244 may include one or more of a variety of devices that enable the cleaning robot 200 to perform cleaning operations proximate to the cleaning robot 200 in response to commands from the control unit 210. In various embodiments, the cleaning units 244 may include brushes, vacuums, wipers, scrubbers, dispensers for cleaning solution, and other suitable cleaning mechanisms.

The radio module 270 may be configured to receive navigation signals, such as signals from aviation navigation facilities, etc., and provide such signals to the processor 220 and/or the navigation unit 222 to assist in cleaning robot navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., the base station 104), a network access point (e.g., the access point 106), a beacon, a smartphone, a tablet, or another computing device with which the cleaning robot 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a cleaning robot operator, a third party service, or a site communication access point. The cleaning robot 200 may communicate with a server through one or more intermediate communication links, such as a wireless telephony network that is coupled to a wide area network (e.g., the Internet) or other communication devices. In some embodiments, the cleaning robot 200 may include and employ other forms of radio communication, such as mesh connections with other cleaning robots or connections to other information sources.

The processor 220 may receive information and instructions generated by the operations manager 225 to schedule and control one or more operations of the cleaning robot 200, including various cleaning operations. In some embodiments, the operations manager 225 may receive information via the communication link 294 from one or more sources external to the cleaning robot 200.

In various embodiments, the control unit 210 may be equipped with an input module 260, which may be used for a variety of applications. For example, the input module 260 may receive images or data from an onboard camera or sensor, or may receive electronic signals from other components (e.g., a payload).

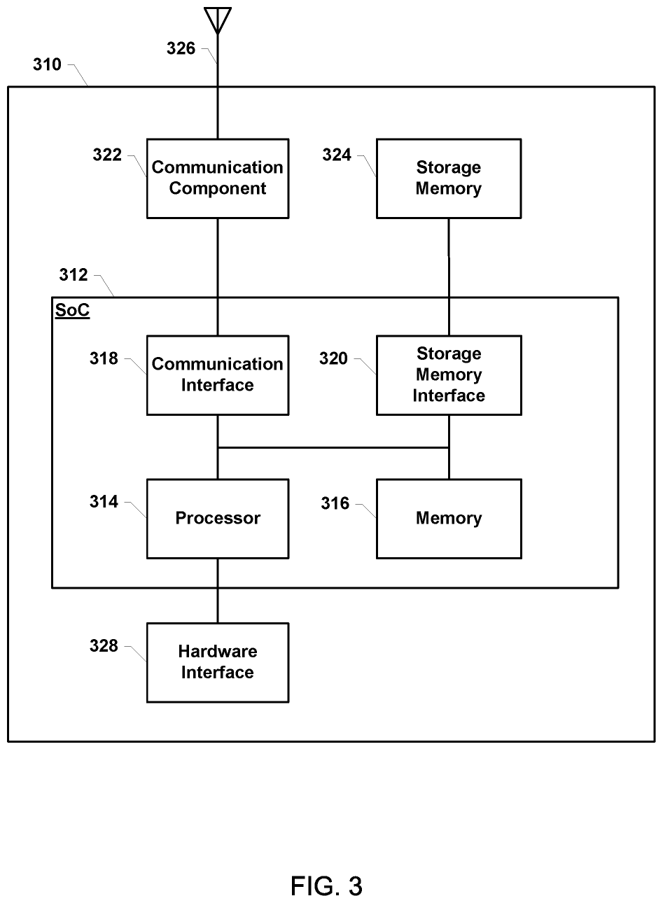

While various components of the control unit 210 are illustrated in FIG. 2 as separate components, some or all of the components (e.g., the processor 220, the output module 250, the radio module 270, and other units) may be integrated together in a single processing device 310, an example of which is illustrated in FIG. 3.

With reference to FIGS. 1-3, the processing device 310 may be configured to be used in a cleaning robot (e.g., the cleaning robot 102 and 200) and may be configured as or including a system-on-chip (SoC) 312. The SoC 312 may include (but is not limited to) a processor 314, a memory 316, a communication interface 318, and a storage memory interface 320. The processing device 310 or the SoC 312 may further include a communication component 322, such as a wired or wireless modem, a storage memory 324, an antenna 326 for establishing a wireless communication link, and/or the like. The processing device 310 or the SoC 312 may further include a hardware interface 328 configured to enable the processor 314 to communicate with and control various components of a cleaning robot. The processor 314 may include any of a variety of processing devices, for example any number of processor cores.

The term “system-on-chip” (SoC) is used herein to refer to a set of interconnected electronic circuits typically, but not exclusively, including one or more processors (e.g., 314), a memory (e.g., 316), and a communication interface (e.g., 318). The SoC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 312 may include one or more processors 314. The processing device 310 may include more than one SoC 312, thereby increasing the number of processors 314 and processor cores. The processing device 310 may also include processors 314 that are not associated with an SoC 312 (i.e., external to the SoC 312). Individual processors 314 may be multicore processors. The processors 314 may each be configured for specific purposes that may be the same as or different from other processors 314 of the processing device 310 or SoC 312. One or more of the processors 314 and processor cores of the same or different configurations may be grouped together. A group of processors 314 or processor cores may be referred to as a multi-processor cluster.

The memory 316 of the SoC 312 may be a volatile or non-volatile memory configured for storing data and processor-executable instructions for access by the processor 314. The processing device 310 and/or SoC 312 may include one or more memories 316 configured for various purposes. One or more memories 316 may include volatile memories such as random access memory (RAM) or main memory, or cache memory.

Some or all of the components of the processing device 310 and the SoC 312 may be arranged differently and/or combined while still serving the functions of the various aspects. The processing device 310 and the SoC 312 may not be limited to one of each of the components, and multiple instances of each component may be included in various configurations of the processing device 310.

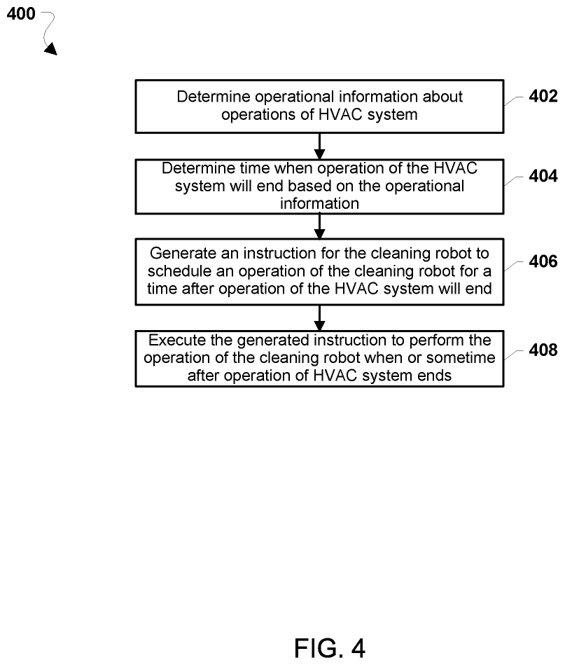

FIG. 4 illustrates a method 400 of managing cleaning robot behavior according to various embodiments. With reference to FIGS. 1-4, a processor of a cleaning robot (e.g., the processor 220, the processing device 310, the SoC 312, and/or the like) and hardware components and/or software components of the cleaning robot may obtain information from one or more sources external to the cleaning robot and dynamically schedule and perform various cleaning robot operations.

In block 402, the processor of the cleaning robot may determine operational information about the operations of an HVAC system. In some embodiments, the observed HVAC system operations may include start times and stop times of operation, days of operation, operational dates and times by correlated to a season, and other suitable operational information. In some embodiments, the processor of the cleaning robot may determine one or more locations of HVAC operation, such as one or more rooms in the structure in which the HVAC system may perform an operation (e.g., heating, ventilation, cooling, and the like). In some embodiments, the processor may obtain HVAC scheduling information from an HVAC manager device (e.g., the HVAC manager device 108) that may store HVAC system scheduling information for at least one room in a structure (e.g., the structure 120). In some embodiments, the HVAC system operational information observed by the processor of the cleaning robot may include one or more temperature thresholds of operation of the HVAC system. In some embodiments, the observed HVAC system operations may include information from a thermostat device in the structure.

In block 404, the processor may determine a time when operation of the HVAC system will end based on the determined operational information. The operation of most heating, ventilation, and air conditioning (HVAC) systems circulates dust and other particulates, which prevents the cleaning robot from cleaning such materials. Thus, in some embodiments, the processor may determine the time when operation of the HVAC system will end to determine when the circulation of such dust and other particulates by the HVAC system may be reduced.

In block 406, the processor may generate an instruction for the cleaning robot to schedule an operation of the cleaning robot for a time after operation of the HVAC system will end. In some embodiments, operation of the cleaning robot may be scheduled to begin at the same time or soon after (essentially when) operation of the HVAC system will end. In some embodiments, operation of the cleaning robot may be scheduled to begin a period of time after operation of the HVAC system will end (e.g., a period of time long enough to permit dust to settle, which may depend upon mess conditions).

In block 408, the processor may execute the generated instruction to perform the operation of the cleaning robot when or sometime after operation of the HVAC system ends.

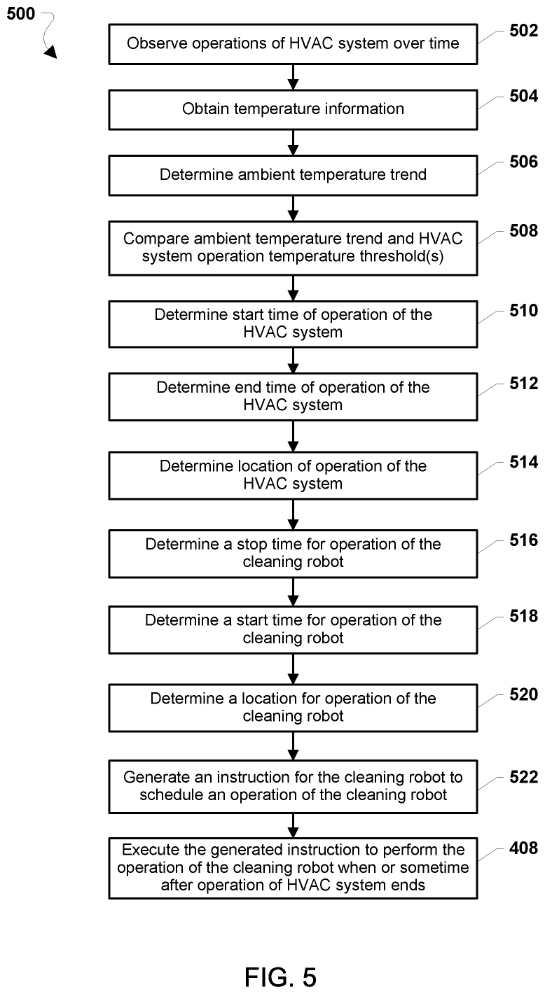

FIG. 5 illustrates a method 500 of managing cleaning robot behavior according to various embodiments. With reference to FIGS. 1-5, a processor of a cleaning robot (e.g., the processor 220, the processing device 310, the SoC 312, and/or the like) and hardware components and/or software components of the cleaning robot may obtain information from one or more sources external to the cleaning robot and dynamically schedule and perform various cleaning robot operations.

In block 502, the processor of the cleaning robot may observe operations of the HVAC system (e.g., the HVAC system 104) over time. In some embodiments, via observations made, e.g., using one or more sensors of the cleaning robot, the processor of the cleaning robot may observe the operations of an HVAC system for at least one room in a structure. In some embodiments, the processor of the cleaning robot may observe (e.g., via one or more sensors of the cleaning robot, such as a temperature sensor, thermometer, humidity sensor, or another suitable sensor) operations of the HVAC system. The observed HVAC system operations may include start times and stop times of operation, days of operation, monthly operation, seasonal operation, and other suitable scheduling information. The information about the HVAC system operations determined by the processor of the cleaning robot may also include one or more locations of HVAC operation, such as a specific room in the structure in which the HVAC system may perform an operation (e.g., heating, ventilation, cooling, and the like).

In some embodiments, the processor of the cleaning robot may also or alternatively obtain information about the HVAC system operations from an HVAC manager device (e.g., the HVAC manager device 108) or another similar device that manages the operation of the HVAC system. The information from the HVAC manager device may include may include HVAC scheduling information, e.g., in a data structure that may be stored in a memory of the HVAC manager device. In some embodiments, the processor of the cleaning robot may be configured to query the HVAC manager device or another similar device via a network (e.g., a wireless network) to obtain the HVAC scheduling information. In some embodiments, the processor of the cleaning robot may be configured to receive the HVAC scheduling information that is pushed to the cleaning robot periodically or upon changes to the HVAC scheduling information. In some embodiments, the processor of the cleaning robot may be configured to store the HVAC scheduling information in memory of the cleaning robot.

In some embodiments, based on the observed HVAC system operations, the processor of the cleaning robot may determine one or more temperature thresholds of operation of the HVAC system. In some embodiments, the temperature thresholds may include a high temperature threshold at which cooling air conditioning may be started and/or a low temperature threshold at which heating air conditioning may be started. For example, HVAC cooling may be triggered when an ambient temperature increases to the high temperature threshold. As another example, HVAC heating may be triggered when an ambient temperature decreases to the low temperature threshold. In some embodiments, the temperature thresholds may include multiple thresholds that trigger various HVAC operations. For example, when an ambient temperature increases to a first high temperature threshold, HVAC ventilation operations may be triggered, and when the ambient temperature increases to a second high temperature threshold, HVAC cooling operations may be triggered. Other examples are also possible. In some embodiments, the processor of the cleaning robot may determine the one or more temperature thresholds of operation of the HVAC system by observation. In some embodiments, the processor may receive the temperature thresholds from the thermostat device (e.g., in response to a query from the cleaning robot, or pushed to the cleaning robot by the thermostat device, or through another machine-to-machine communication).

In block 504, the processor may obtain information regarding the ambient temperature. In some embodiments, the processor may obtain information regarding the ambient temperature from and onboard temperature sensor (e.g., 242). In some embodiments, the processor may obtain information regarding the ambient temperature from a thermostat device of the HVAC system, such as via a wireless data link. In some embodiments, the information from the thermostat device may include information about an ambient temperature around the thermostat device. In some embodiments, the information from the thermostat device may include one or more temperature thresholds of operation of the HVAC system. In some embodiments, the information from the thermostat device may include historical information about the operation of the thermostat device.

In block 506, the processor may determine an ambient temperature trend. For example, the processor may obtain temperature information (e.g., from the thermostat device) over time, and based on the temperature information over time the processor may determine one or more ambient temperature trends. In some embodiments, an ambient temperature trend may include an upward trend and/or downward trend. In some embodiments, an ambient temperature trend may be a curve or other variation of temperature over time (i.e., may include increasing, decreasing and or steady state temperature information).

In block 508, the processor may compare the ambient temperature trend and one or more temperature thresholds of operation of the HVAC system.

In block 510, the processor may determine a start time of a next operation of the HVAC system, or a schedule of start times of HVAC system operations.

In block 512, the processor may determine a stop or end time of the next operation of the HVAC system (i.e., a time when the next HVAC system operation will end), or a schedule of stop/end times of HVAC system operations.

In block 514, the processor may determine a location of operation of the HVAC system, such as a particular room within a structure or a location of HVAC outlets with respect to the location of the cleaning robot.

In some embodiments, the processor may determine the start time, end time, and/or location of operation of the HVAC system based on the observed operations of the HVAC system. In some embodiments, the processor may determine the start time, end time, and/or location of operation of the HVAC system based on the thermostat device information. In some embodiments, the processor may determine the start time, end time, and/or location of operation of the HVAC system based on the observed operations of the HVAC system and the thermostat device information. In some embodiments, the processor may determine the start time, end time, and/or location of operation of the HVAC system based on the comparison of the ambient temperature trend and the one or more temperature thresholds of operation of the HVAC system.

In block 516, the processor may determine a stop time for operation of the cleaning robot. In some embodiments, the processor may determine the stop time for the cleaning robot operation based on the start time and/or location of operation of the HVAC system within the structure such that cleaning robot can cease cleaning operations before the HVAC system stirs up dust and particles.

In block 518, the processor may determine a start time for operation of the cleaning robot. In some embodiments, the processor may determine the start time for the cleaning robot operation based on the end time and/or location of operation of the HVAC system within the structure. In some embodiments, the start time for the operation of the cleaning robot may include a period of time after the time that the operation of the HVAC system ends. For example, the processor may include a period of time (e.g., a delay time period) after the HVAC system operation ends to enable dust and other particulates to settle so that the cleaning robot may function more effectively.

In block 520, the processor may determine a location for operation of the cleaning robot. In some embodiments, the processor may determine the location for operation of the cleaning robot based on the location of operation of the HVAC system.

In some embodiments, the processor may determine the start time for operation of the cleaning robot, the stop time for operation of the cleaning robot, and or the location for operation of the cleaning robot based on a combination of time(s) and/or location(s) of operation of the HVAC system. For example, in response to determining that the HVAC system is scheduled to operate in a first room of the structure at a first time, the processor may determine to schedule operation of the cleaning robot in a second room at the first time. As another example, in response determining that the HVAC system is scheduled operate in the first room until a second time, the processor may determine to schedule operation of the cleaning robot in the first room after the second time. As another example, in response determining that the HVAC system is scheduled to operate in the first room at the first time, the processor may determine a stop time for operation of the cleaning robot in the first room prior to the first time.

In block 522, the processor may generate an instruction for the cleaning robot to schedule and operation of the cleaning robot. In some embodiments, the generated instruction may schedule the operation of the cleaning robot based on one or more of the determined stop time, the determined start time, and the determined location for operation of the cleaning robot.

In block 408, the processor may execute the generated instruction to perform the operation of the cleaning robot as described.

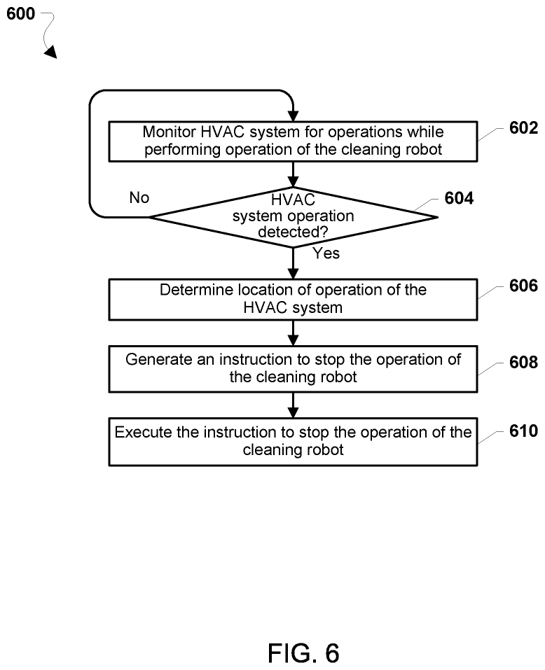

FIG. 6 illustrates a method 500 of managing cleaning robot behavior according to various embodiments. With reference to FIGS. 1-6, a processor of a cleaning robot (e.g., the processor 220, the processing device 310, the SoC 312, and/or the like) and hardware components and/or software components of the cleaning robot may obtain information from one or more sources external to the cleaning robot and dynamically schedule and perform various cleaning robot operations. The method 600 illustrates an example of operations that may be performed in block 408 of the method 400.

In the event that the HVAC system begins operations unexpectedly while the cleaning robot is performing one or operations, the HVAC system may begin blowing and/or circulating dust in one or more locations of the structure. For example, a user may manually activate the HVAC system. As another example, a system fault may trigger operation of the HVAC system. Performing operations while the HVAC system is operating may reduce the effectiveness of any cleaning robot operations. Thus, while performing one or more operations, the processor of the cleaning robot may monitor the HVAC system to determine or detect unexpected operation or activation of the HVAC system and discontinue cleaning robot operations.

In block 602, the processor of the cleaning robot may monitor the HVAC system for operations while performing the operation of the cleaning robot.

In determination block 604, the processor of the cleaning robot may determine whether any HVAC system operation is detected.

In response determining that no HVAC system operation is detected (i.e., determination block 604=“No”), the processor may continue to monitor the HVAC system for operations.

In response to detecting HVAC system operation while the cleaning robot is operating (i.e., determination block 604=“Yes”), the processor may determine a location of operation of the HVAC system in block 606.

In block 608, the processor of the cleaning robot may generate an instruction to stop the operation of the cleaning robot. In some embodiments, the processor may generate the instruction to stop the operation of the cleaning robot based on the determined location of the operation of the HVAC system and the determination that HVAC system operation is detected.

In block 610, the processor of the cleaning robot may execute the instruction to stop the operation of the cleaning robot.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400, 500, and 600 may be substituted for or combined with one or more operations of the methods 400, 500, and 600, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of managing cleaning behavior by a cleaning robot, comprising:
determining, by a processor of a cleaning robot, operational information about operations of a heating, ventilation, and air conditioning (HVAC) system for at least one room in a structure in which the cleaning robot is located;
determining, by the processor, a time when operation of the HVAC system will end based on the determined operational information;
generating, by the processor, an instruction to schedule an operation of the cleaning robot for a time after operation of the HVAC system will end; and
executing, by the processor, the generated instruction to perform the operation of the cleaning robot after operation of the HVAC system ends.

2. The method of claim 1, wherein the determined operational information about operations of the HVAC system comprises an HVAC system operation schedule.

3. The method of claim 1, wherein the determined operational information about operations of the HVAC system comprises information received from a thermostat device of the HVAC system.

4. The method of claim 1, wherein determining operational information about operations of the HVAC system comprises:
observing, by the processor, operations of the HVAC system for the at least one room in the structure over time; and
determining, by the processor, operational information about the operations of the HVAC system based on the observations.

5. The method of claim 1, wherein determining operational information about operations of the HVAC system comprises:
observing, by the processor, ambient temperatures in the at least one room in the structure over time;
observing, by the processor, operations of the HVAC system for the at least one room in the structure over time;
correlating, by the processor, observed operations of the HVAC system to observed ambient temperatures; and
determining, by the processor, operational information about the operations of the HVAC system based on correlations of observed operations of the HVAC system to observed ambient temperatures.

6. The method of claim 1, wherein generating an instruction to schedule an operation of the cleaning robot for a time after operation of the HVAC system will end comprises scheduling the operation of the cleaning robot to begin a period of time after the time when operation of the HVAC system will end.

7. The method of claim 1, wherein generating an instruction to schedule an operation of the cleaning robot based on the time when operation of the HVAC system ends comprises:
determining a location of operation of the HVAC system within the structure; and
determining a location for operations of the cleaning robot based on the determined location of operation of the HVAC system within the structure.

8. The method of claim 1, wherein generating an instruction to schedule an operation of the cleaning robot based on the time when operation of the HVAC system ends comprises:
determining a start time of the operation of the HVAC system; and
determining a stop time of the operation of the cleaning robot based on the start time of the operation of the HVAC system.

9. The method of claim 1, further comprising:
observing, by the processor, ambient temperatures in the at least one room in the structure over time; and
determining, by the processor, an ambient temperature trend based on the observed ambient temperatures,
wherein determining the time when operation of the HVAC system will end based on the determined operational information comprises determining, by the processor, the time when operation of the HVAC system will end based on a comparison of the ambient temperature trend and a temperature threshold of operation of the HVAC system.

10. The method of claim 1, further comprising:
observing, by the processor, ambient temperatures in the at least one room in the structure over time;
determining, by the processor, an ambient temperature trend based on the observed ambient temperatures;
determining, by the processor, a start time for operation of the HVAC system based on a comparison of the ambient temperature trend and a temperature threshold of operation of the HVAC system;
determining, by the processor, a stop time for operation of the cleaning robot based on the determined start time of the operation of the HVAC system;
generating, by the processor, an instruction to schedule stopping operations of the cleaning robot at the determined stop time; and
executing, by the processor, the generated instruction to stop operations of the cleaning robot.

11. The method of claim 1, further comprising:
monitoring, by the processor, for HVAC system operations while performing the operation of the cleaning robot; and
executing, by the processor, an instruction to stop the operation of the cleaning robot in response to detecting HVAC system operation while performing the operation of the cleaning robot.

12. A cleaning robot, comprising:
a memory; and
a processor coupled to the memory and configured with processor-executable instructions to:
determine operational information about operations of a heating, ventilation, and air conditioning (HVAC) system for at least one room in a structure in which the cleaning robot is located;
determine a time when operation of the HVAC system will end based on the determined operational information;
generate an instruction to schedule an operation of the cleaning robot for a time after operation of the HVAC system will end; and
execute the generated instruction to perform the operation of the cleaning robot after operation of the HVAC system ends.

13. The cleaning robot of claim 12, wherein the processor is further configured with processor-executable instructions such that the determined operational information about operations of the HVAC system comprises an HVAC system operation schedule.

14. The cleaning robot of claim 12, wherein the processor is further configured with processor-executable instructions such that the determined operational information about operations of the HVAC system comprises information received from a thermostat device of the HVAC system.

15. The cleaning robot of claim 12, wherein the processor is further configured with processor-executable instructions to:
observe operations of the HVAC system for the at least one room in the structure over time; and
determine operational information about the operations of the HVAC system based on the observations.

16. The cleaning robot of claim 12, wherein the processor is further configured with processor-executable instructions to:
observe ambient temperatures in the at least one room in the structure over time;
observe operations of the HVAC system for the at least one room in the structure over time;
correlate observed operations of the HVAC system to observed ambient temperatures and
determine operational information about the operations of the HVAC system based on correlations of observed operations of the HVAC system to observed ambient temperatures.

17. The cleaning robot of claim 12, wherein the processor is further configured with processor-executable instructions to schedule the operation of the cleaning robot to begin a period of time after the time when operation of the HVAC system will end.

18. The cleaning robot of claim 12, wherein the processor is further configured with processor-executable instructions to:
determine a location of operation of the HVAC system within the structure; and
determine a location for operations of the cleaning robot based on the determined location of operation of the HVAC system within the structure.

19. The cleaning robot of claim 12, wherein the processor is further configured with processor-executable instructions to:
determine a start time of the operation of the HVAC system; and
determine a stop time for the operation of the cleaning robot based on the start time of the operation of the HVAC system.

20. The cleaning robot of claim 12, wherein the processor is further configured with processor-executable instructions to:
observe ambient temperatures in the at least one room in the structure over time;
determine an ambient temperature trend based on the observed ambient temperatures; and
determine the time when operation of the HVAC system will end based on a comparison of the ambient temperature trend and a temperature threshold of operation of the HVAC system.

21. The cleaning robot of claim 12, wherein the processor is further configured with processor-executable instructions to:
observe ambient temperatures in the at least one room in the structure over time;
determine an ambient temperature trend based on the observed ambient temperatures;
determine a start time for operation of the HVAC system based on a comparison of the ambient temperature trend and a temperature threshold of operation of the HVAC system;
determine a stop time for operation of the cleaning robot based on the determined start time of the operation of the HVAC system;
generate an instruction to schedule stopping operations of the cleaning robot at the determined stop time; and
execute the generated instruction to stop operations of the cleaning robot.

22. The cleaning robot of claim 12, wherein the processor is further configured with processor-executable instructions to:
monitor for HVAC system operations while performing the operation of the cleaning robot; and
execute an instruction to stop the operation of the cleaning robot in response to detecting HVAC system operation while performing the operation of the cleaning robot.

23. A cleaning robot, comprising:
means for determining operational information about operations of a heating, ventilation, and air conditioning (HVAC) system for at least one room in a structure in which the cleaning robot is located;
means for determining a time when operation of the HVAC system will end based on the determined operational information;
means for generating an instruction to schedule an operation of the cleaning robot for a time after operation of the HVAC system will end; and
means for executing the generated instruction to perform the operation of the cleaning robot after operation of the HVAC system ends.

24. A non-transitory, processor-readable medium having stored thereon processor-executable instructions configured to cause a processor of a cleaning robot to perform operations comprising:
determining operational information about operations of a heating, ventilation, and air conditioning (HVAC) system for at least one room in a structure in which the cleaning robot is located;
determining a time when operation of the HVAC system will end based on the determined operational information;
generating an instruction to schedule an operation of the cleaning robot for a time after operation of the HVAC system will end; and
executing the generated instruction to perform the operation of the cleaning robot when the operation of the HVAC system ends.
